(19) United States
(12) Patent Application Publication
(10) Pub. No.: US 2002/0137392 A1
(43) Pub. Date: Sep. 26, 2002

(54) Patch cord cable manager

(76) Inventor: Norman J. Wainio, Milford, MA (US)

Correspondence Address: DEVINE, MILLIMET & BRANCH, P.A., 111 AMHERST STREET, BOX 719, MANCHESTER, NH, 03105, US

(21) Appl. No.: 09/817,684

(22) Filed: Mar. 26, 2001

(51) Int. Cl. H01R 9/11

(52) U.S. Cl. 439/623

(57) ABSTRACT

This invention is a cable management device for organizing multiple cables and multiple cable connection, primarily patch cords. The device includes an enclosure means for at least partially holding multiple cables. The device also includes an engaging mechanism for enabling synchronistical connection and disconnection of the multiple cables.

### FIELD OF THE INVENTION

The invention relates generally to the field of electrical connectors. Specifically, invention relates to the field of telecommunication device connectors.

### BACKGROUND OF THE INVENTION

With the advent of computer networks, commercial buildings have taken on significant needs toward building up telecommunications infrastructures. It is not uncommon to find one or more telecommunications closets on every level of a commercial building. Each of these telecommunications closets is normally filled with servers and other network devices connecting the floor or a portion of the floor to the outside world.

For every jack provided with a connection to the network, there is a patch cord or a need for a patch cord in the telecommunications closet interconnecting telecommunications devices. A single telecommunications closet can have over a hundred patch cords. A commercial building containing a few hundred workers can easily have up to a thousand patch cords between all of the telecommunications rooms. Each one of these patch cords takes time to connect. The exorbitant number of patch cords creates a demand for increasing efficiency of patch cord installation.

The large number of patch cords also creates a very confusing array of wires in the back of telecommunications racks. This array of wires makes locating specific patch cords difficult. There are several devices for managing wires to give the appearance of neatness in the telecommunications closet, but very few of these devices organize the patch cords in a meaningful way. There remains a need in the market for a device for organizing wires in such a way that wires can be followed between patched devices.

### SUMMARY OF THE INVENTION

This invention is the result of the realization that ganging together multiple patch cords with a feature for their synchronistical connection and disconnection greatly improves the organization and efficiency of installing and managing patch cords connecting telecommunications devices.

Therefore it is an object of this invention to make connection and disconnection of multiple patch cords faster.

It is a further object of this invention to allow patch cords to be installed in a more organized fashion.

### BRIEF DESCRIPTION OF THE DRAWINGS

The novel features believed characteristic of the invention are set forth in the claims. The invention itself however, as well as other features and advantages thereof, will be best understood by reference to the description which follows, read in conjunction with the accompanying drawings, wherein:

FIG. 1 is an angled view of the invention.

FIG. 2 is an exploded view of the invention.

### DETAILED DESCRIPTION OF THE INVENTION

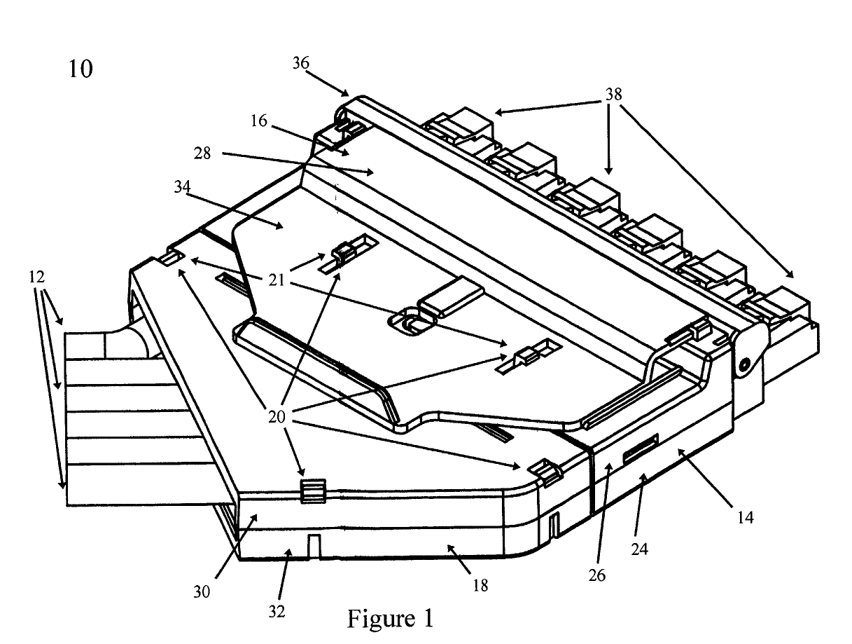

This invention, as shown in FIG. 1 is a cable management device 10 for organizing multiple cables 12 and multiple cable connection, primarily patch cords. The device 10 includes an enclosure means 14 for at least partially holding multiple cables 12. The device also includes an engaging mechanism 16 for enabling synchronistical connection and disconnection of the multiple cables 12.

A narrower embodiment of the invention 10 includes an extension 18 of the enclosure means 14 for angling the direction of the multiple cables 12 from the enclosure means 14. Another narrower embodiment of the invention 10 includes a securing means 20 for threadably 42 securing the multiple cables 12 within the enclosure means 14. A similar narrower embodiment of the invention 10 includes a securing means 20 for securing the enclosure means 14 about the multiple cables 12 with latches 21. The invention 10 may also include a combination of these narrower ideas by redundantly making the securing means 20 a combination of threadably securing the enclosure means 14 about the multiple cables 12 and securing the enclosure means 14 about the multiple cables 12 with latches 21.

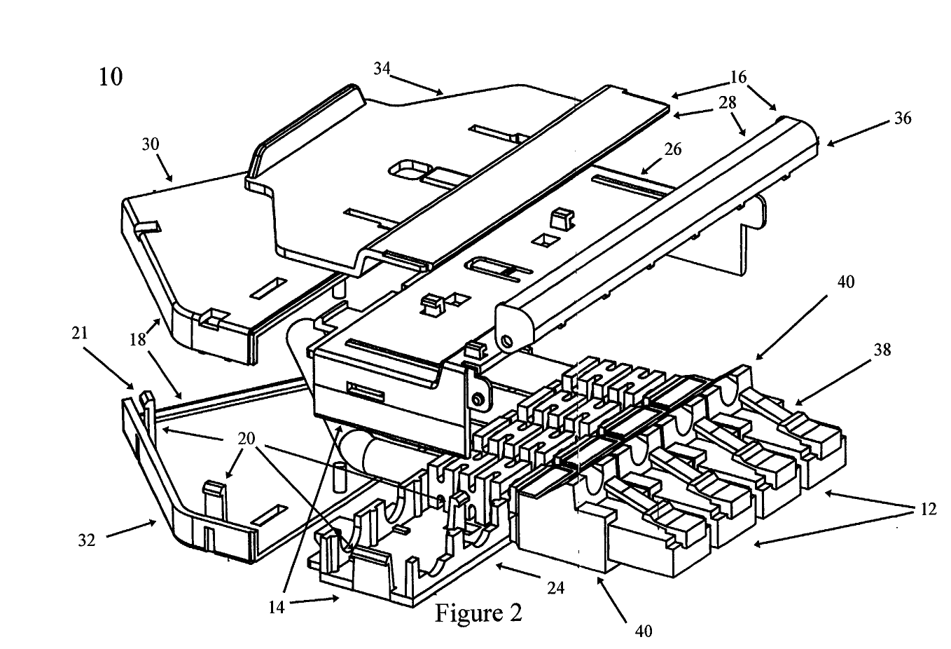

From another perspective, shown in FIG. 2, the invention 10 is a cable management apparatus 10 for organizing multiple cables 12 attached to a telecommunications device, primarily patch cords. The inventive apparatus 10 includes a lower shell 24 and an upper shell 26 attachable to the lower shell. The invention 10, from this perspective, further includes an engaging means 28, slidably mounted on the upper shell 26 for enabling synchronistical connection and disconnection of the multiple cables 12.

A narrower version of this perspective of this invention 10 includes an upper cable guide 30 and lower cable guide 32 connected to the upper shell 26 and lower shell 24 for angling the cables 12 in a specific direction from the upper 26 and lower shell 24. Another narrower version of this perspective of this invention 10 includes a securing means 20 for threadably securing the upper 26 and lower shell 24 about the multiple cables 12. A narrower aspect of the invention 10 may also include a securing means 20 for securing the upper 26 and lower shell 24 about the multiple cables 12 with latches 21.

The engaging means 28 can be comprised of an actuator 34 slidably mounted on the upper shell 26 and a release bar 36 pivotably attached to the upper shell 26 wherein when the actuator 34 slides toward the release bar 36, the release bar 36 pivots onto terminations 38 for the multiple cables 12, allowing disengagement from the telecommunications device.

Another aspect of the invention 10 could require each of the multiple cables 12 possesses a cable attachment 40, which is interlockable with the cable management apparatus 10. In the instant case, the cable attachments 40 are cable stress relievers, although the cable attachments 40 need not have the additional function of relieving cable stress.

This invention 10 is also capable of being a field configurable cable management kit for organizing multiple cables 12 attached to a telecommunications device, primarily patch cords. The necessary elements for this kit 10 include a lower shell 24, an upper shell 26 attachable to the lower shell 24, and an engaging means 28, slidably mountable on one of the shells 24 and 26. The cable management kit 10 may also include an upper cable guide 30 and a lower cable guide 32 connectable to the upper cable guide 30, wherein at least one of the cable guides 30 and 32 is connectable to at least one of the shells 24 and 26, for angling the cables 12 in a specific direction from the shells 24 and 26.

The engaging means 28 may further include an actuator 34 slidably mountable on one of the shells 24 and 26 and a release bar 36 pivotably attachable to one of the shells 24 and 26. This design of the engaging means 28 intends for the actuator 34 to slide toward the release bar 36, causing the release bar 36 to pivot onto terminations 38 for the multiple cables 12, allowing disengagement from the telecommunications device.

In one embodiment, the kit 10 is built to have at least two kit 10 elements interlockable with latches 21. In a similar embodiment the kit 10 is built to have at least two kit 10 elements threadably attachable.

Although the present invention has been described with the above-identified embodiments, those skilled in the art will recognize that changes may be made in form and detail of structure and operation without departing from the spirit and scope of the invention.

Accordingly, what is claimed is:

1. A cable management device for organizing multiple cables and multiple cable connection, primarily patch cords, comprising:
an enclosure means for at least partially holding multiple cables; and
an engaging mechanism for enabling synchronistical connection and disconnection of the multiple cables.

2. The cable management device of claim 1 further comprising an extension of the enclosure means for angling the direction of the multiple cables from the enclosure means.

3. The cable management device of claim 1 further comprising a securing means for threadably securing the multiple cables within the enclosure means.

4. The cable management device of claim 1 further comprising a securing means for securing the enclosure means about the multiple cables with latches.

5. The cable management device of claim 4 where in the securing means further includes a redundant securing means of threadably securing the enclosure means about the multiple cables.

6. A cable management apparatus for organizing multiple cables attached to a telecommunications device, primarily patch cords, comprising:
a lower shell;
an upper shell attachable to the lower shell; and
an engaging means, slidably mounted on one of the shells for enabling synchronistical connection and disconnection of the multiple cables.

7. The cable management apparatus of claim 6 further comprising an upper and lower cable guide connected to the upper and lower shell for angling the cables in a specific direction from the upper and lower shell.

8. The cable management apparatus of claim 6 further comprising a securing means for threadably securing the upper and lower shell about the multiple cables.

9. The cable management apparatus of claim 6 wherein the engaging means comprises:
an actuator slidably mounted on the upper shell; and
a release bar pivotably attached to the upper shell wherein when the actuator slides toward the release bar, the release bar pivots onto terminations for the multiple cables, allowing disengagement from the telecommunications device.

10. The cable management apparatus of claim 6 wherein each of the multiple cables possesses a cable attachment which is interlockable with the cable management apparatus.

11. The cable management apparatus of claim 6 wherein further comprising a securing means for securing the upper and lower shell about the multiple cables with latches.

12. A field configurable cable management kit for organizing multiple cables attached to a telecommunications device, primarily patch cords, said kit parts comprising:
a lower shell;
an upper shell attachable to the lower shell; and
an engaging means, slidably mountable on one of the shells for enabling synchronistical connection and disconnection of the multiple cables.

13. The cable management kit of claim 12 further comprising:
an upper cable guide; and
a lower cable guide connectable to the upper cable guide, wherein at least one of the cable guides is connectable to at least one of the shells, for angling the cables in a specific direction from the shells.

14. The cable management kit of claim 12 wherein the engaging means comprises:
an actuator slidably mountable on one of the shells; and
a release bar pivotably attachable to one of the shells wherein when assembled the actuator slides toward the release bar, the release bar pivots onto terminations for the multiple cables, allowing disengagement from the telecommunications device.

15. The cable management kit of claim 12 wherein at least two kit elements are interlockable with latches.

16. The cable management kit of claim 12 wherein at least two kit elements are threadably attachable.
